(19) United States
(12) Patent Application Publication
(10) Pub. No.: US 2010/0251762 A1
(43) Pub. Date: Oct. 7, 2010

(54) Water crystallizer employing mercury wetted surface

(76) Inventor: Colin Alder Connery, Yonkers, NY (US)

Correspondence Address: Colin Connery, Room 319, 17 Riverdale Avenue, Yonkers, NY, 10701, US

(21) Appl. No.: 12/384,360

(22) Filed: Apr. 3, 2009

(51) Int. Cl. C02F 1/22; B01D 9/00; C23F 13/12

(52) U.S. Cl. 62/532; 62/123; 204/196.01

(57) ABSTRACT

A dendritic ice crystallizer having a mercury wetted surface (14) from which heat is extracted while the mercury wetted surface is in contact with water at the freezing temperature. The mercury wetted surface can be protect from ionization or corrosion by a cathodic protection means (68). In addition, new or recycled mercury can be used to displace old mercury on the mercury wetted surface (56) in situ by inclining the mercury wetted surface from the horizontal and depositing mercury from a mercury nozzle (60) to the high end of the mercury wetted surface and collecting displaced mercury with a mercury collector (62) at the low end of the mercury wetted surface.

### CROSS-REFERENCE TO RELATED APPLICATIONS

Not applicable

### FEDERALLY SPONSORED RESEARCH

Not applicable

### SEQUENCE LISTING OR PROGRAM

Not applicable

### BACKGROUND

1. Field

This application relates to water crystallization, specifically to crystallizers which are used to generate free floating dendritic ice crystals.

2. Prior Art

One method of desalinating water is known as ice cycle desalination. In this process ice is manufactured from saline water and then melted to obtain pure water. This method has the theoretical advantage of being energy efficient when compared to vapor cycle desalination. This is because the heat transport requirement of the ice cycle is only 14% of that required by the vapor cycle.

Another advantage of the ice cycle is that the ice can be manufactured at night when electricity rates are low and then melted during the day to provide air-conditioning at a time when electricity is quite expensive. Thus the desalination process becomes a cost free by-product of a cost efficient thermal storage air-conditioning technology.

The main problem with ice cycle desalination is the lack of a simple and energy efficient way to manufacture the ice. One method is to grow the ice on a cooling surface. This gives rise to two problems. The first problem is that the growing layer of ice insulates the cooling surface from the water thereby making the cooling process less efficient. This problem gives rise to the need to periodically release the ice from the cooling surface. One common method for releasing the ice is to periodically heat the cooling surface, but this in itself introduces energy inefficiency.

Many attempts have been made to create a cooling surface to which ice can't attach. While these efforts have so far been unsuccessful there has been success in using a mechanical process in which a rolling “whip rod” rapidly and continuously rolls over the inner surface of a heat exchanger tube thereby preventing the attachment of ice. An example of such an apparatus is found in U.S. Pat. No. 5,953,924 to Li et al. (1999). These attempts are limited due to the energy requirement for moving and rotating the whip rod and also the considerable mechanical complexity of the apparatus.

Another conceptually simple way to manufacturing ice is to chill water to the freezing temperature in an insulated vessel and then remove water vapor from the water with a vacuum pump. When the vapor pressure over the water is reduced to below 4.6 millimeters of mercury absolute pressure the boiling point of the water is so depressed that it becomes equal to the freezing point of water. This is the so called triple point of water. Thus, by removing the water vapor from water at the triple point, the heat of vaporization is extracted from the water thereby super cooling the water which promotes the growth of free floating dendritic ice crystals. Two examples of this method can be found in U.S. Pat. No. 4,003,213 to Cox (1977) and U.S. Pat. No. 5,003,784 to Engdahl et al. (1991).

The primary limitations of the triple point method arise from the highly rarefied character of the water vapor. When employing the triple point method to desalinate water a very large volume of vapor must be compressed and moved from the triple point vessel to the ice melter in order to obtain a relatively small quantity of fresh water. When the triple point process is used to manufacture ice for melting to provide air-conditioning the additional need to isothermally compress the water vapor to the much higher vapor pressure of water at the ambient temperature is, as a practical matter, beyond the capacity of modern compressor and heat exchanger technology. As a result triple point methods have not proved commercially viable.

Another proposed method for growing free floating dendritic ice crystals is found in U.S. Pat. No. 4,164,854 to Martin (1979). The freezing is accomplished by injecting a finely atomized spray of precooled mercury into a vertically elongated tank filled with saline water to absorb heat from the water and initiate the formation of ice crystals. The mercury is continuously recirculated though a cooling means.

One limitation of this process is the low specific heat of mercury which is 3.35% of the specific heat of water. Thus a very considerable quantity of mercury must be circulated to accomplish a relatively small amount of ice crystallization. The resulting power requirement for the mercury pumping mechanism significantly diminishes the over all efficiency of the cooling mechanism.

A second concern is the tendency of the mercury to ionize (corrode) while in contact with the saline water. This results in the escape of mercury out the waste stream and poses an environmental hazard.

### SUMMARY

A first embodiment takes advantage of that property of mercury which enables it to wet and tenaciously cling to a suitably treated metal surface. Thus a properly mercury wetted cooling surface exposed to water will present a true liquid surface to which ice can't adhere.

A second embodiment provides the mercury surface with a cathodic protection means to suppress the tendency of the mercury to ionize (corrode).

A third embodiment includes a means to periodically or continuously renew the mercury surface in situ.

### DRAWINGS—FIGURES

FIGS. 1A and 1B show an orthogonal side cross-section view of the first embodiment.

FIG. 2 shows a schematic representation of an apparatus employing the first embodiment.

FIG. 3 shows an orthogonal side cross-section of an apparatus employing a second and a third embodiment.

### DRAWINGS—REFERENCE NUMERALS

| | | | |
|---|---|---|---|
| 10 | evaporator | 12 | evaporator base |
| 13 | flat rectangular plate of nickel | | |
| 14 | mercury wetted surface | 16 | heat insulation |
| 18 | liquid inlet | 20 | vapor outlet |
| 22 | flotation ice wash column | 24 | ice/water storage tank |
| 26 | crystallizer apparatus | 28 | condenser |
| 30 | heat pump | 32 | ambient condenser |
| 34 | saline water inlet pump | 36 | saline water outlet pump |
| 38 | paddle wheel | 40 | fresh water pump |
| 42 | ice melter | 44 | circulation pump |
| 46 | wash column salinity sensor | 48 | harvest water salinity sensor |
| 50 | crystallizer salinity sensor | 52 | evaporator |
| 54 | nickel foil | 56 | mercury wetted surface |
| 58 | thermal grease | 60 | mercury nozzle |
| 61 | mercury wetted wire | | |
| 62 | mercury collector | 64 | mercury pump |
| 68 | power supply | 70 | anode |

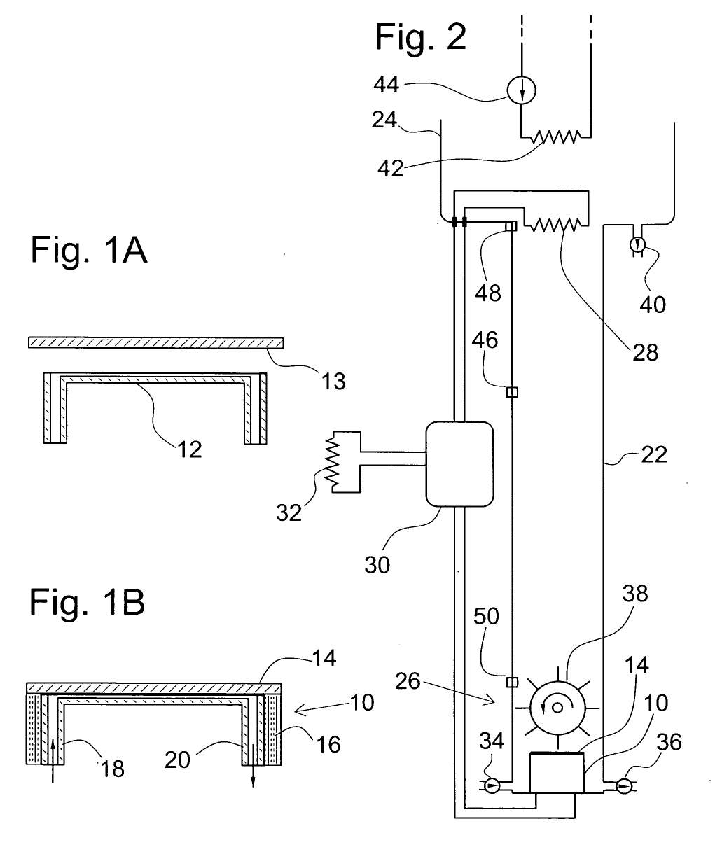

### DETAILED DESCRIPTION—FIGS. 1A, 1B AND 2—FIRST EMBODIMENT

FIGS. 1A and 1B show a heat pump evaporator 10 consisting of an evaporator base 12 having an open top and a flat rectangular plate of nickel 13. FIG. 1A shows evaporator 10 with evaporator base 12 and flat rectangular plate of nickel 13 separated. FIG. 1B shows evaporator 10 with evaporator base 12 adhesively joined to flat rectangular plate of nickel 13 having an upward facing mercury wetted surface 14. In addition FIG. 1B shows the sides of evaporator 10 covered with heat insulation 16. The liquid refrigerant enters evaporator 10 through a liquid inlet 18 and exits as a vapor through a vapor outlet 20.

FIG. 2 shows evaporator 10 of FIG. 1B incorporated into a flotation ice wash column 22 in accordance with the apparatus and method disclosed in my U.S. Pat. No. 4,833,520 (1989).

Flotation ice wash column 22 is a vertically oriented duct having a plumb central axis in open communication at the top end with the base of an ice/water storage tank 24. The lower end of the flotation ice wash column 22 contains a crystallizer apparatus 26. In operation flotation ice wash column 22 will be filled with a column of water which is effectively stratified so that the concentration of dissolved salts increase from the top with depth down to crystallizer apparatus 26 which contains water of maximum salinity. Located in the upper end of flotation ice wash column 22 there is a condenser 28. A heat pump 30 is used to transport heat from evaporator 10 to condenser 28. Additionally heat pump 30 can be used to transport heat from the evaporator 10 to an ambient condenser 32 which discharges heat to the surrounding environment.

Saline water is fed into crystallizer apparatus 26 through a saline water inlet pump 34. Water of maximum salinity is withdrawn from crystallizer apparatus 26 by a saline water outlet pump 36. The saline water in crystallizer apparatus 26 is kept in constant circulation by means of a paddle wheel 38.

Fresh water is withdrawn from the bottom of an ice/water storage tank 24 by a fresh water pump 40. Located in the top of ice/water storage tank 24 where ice accumulates is an ice melter 42. A circulation pump 44 is used to circulate a secondary refrigerant around a loop between ice melter 42 and air-conditioning heat exchangers (not shown).

The salinity of the water in flotation ice wash column 22 is monitored at three levels. Midway up flotation ice wash column 22 there is a wash column salinity sensor 46. At the top of flotation ice wash column 22 there is a harvest water salinity sensor 48. A third sensor; crystallizer salinity sensor 50, is at the level of crystallizer apparatus 26.

### Operation—FIGS. 1A, 1B and 2

Evaporator 10 has as its top flat rectangular plate of nickel 13 that has an upward facing mercury wetted surface 14. Mercury wetted surface 14 is created by annealing flat rectangular plate of nickel 13 and then plating the upper face of flat rectangular plate of nickel 13 with a light coating of gold. Flat rectangular plate of nickel 13 is then bonded to the open top of evaporator base 12 using an epoxy or methacrylate adhesive. Finally, when evaporator 10 is in position in crystallizer apparatus 26, a small quantity of mercury is deposited on the upper face of flat rectangular plate of nickel 13. The mercury quickly spreads across the upper face of flat rectangular plate of nickel 13 amalgamating with the gold and wetting the nickel surface. This completes the fabrication of evaporator 10.

It should be noted that while this discussion assumes the use of a primary refrigerant, one can just as easily use a secondary refrigerant that remains a liquid in its passage through evaporator 10. It should also be noted that the apparatus of FIG. 2 should be heat insulated. To enhance the clarity of the drawing, such insulation is not shown.

Operation of the apparatus of FIG. 2 begins by filling flotation ice wash column 22 with saline water through saline water inlet pump 34 up to the top of flotation ice wash column 22 corresponding to the level of condenser 28. Next heat pump 30, pumps heat from evaporator 10 to ambient condenser 32 and paddle wheel 38 begins rotating.

When evaporator 10 has chilled the saline water in crystallizer apparatus 26 to the freezing temperature, dendritic ice crystals will begin to form in the supercooled water adjacent to mercury wetted surface 14. The purpose of paddle wheel 38 is to keep the saline water circulating over mercury wetted surface 14. Without circulation, the saline water immediately adjacent to mercury wetted surface 14 will become excessively saline thereby depressing the local temperature. This will lower the thermodynamic efficiency of heat pump 30 and will ultimately result in the precipitation of salt out of solution and onto mercury wetted surface 14.

With the passage of time ice crystals floating up flotation ice wash column 22 will reach condenser 28, at which point heat pump 30 will begin discharging heat through condenser 28. This heat will melt a first portion of ice creating a layer of water that is less saline than the water beneath. A next portion of ice will float up through the first layer of less saline water causing the next portion of ice to be rinsed by the first layer. Next this second portion of ice will melt creating a new layer of water on top of the first layer that is less saline than the first layer.

By the continuous repetition of this rinsing and melting process the entire column of water will become highly stratified ranging from extremely fresh at the top to maximally saline at the bottom.

When flotation ice wash column 22 has become fully stratified the apparatus of FIG. 2 is ready to begin to produce fresh water directly, or it can prepare to accumulate ice in ice/water storage tank 24 for use at a later time to provide cold as in air-conditioning.

To maintain a properly stratified flotation ice wash column 22 it is necessary to monitor the salinity of the water at various levels within flotation ice wash column 22. This can be accomplished by using sensors that monitor temperature thereby revealing freezing point depression or sensors that measure the bulk electrical resistance of the water. Bulk electrical resistance is an especially good way to measure the very high degrees of water purity that can be realized at the top of a flotation ice wash column.

When operating the apparatus of FIG. 2 in fresh water generation mode heat pump 30 will continue to discharge the great majority of the heat from evaporator 10 through condenser 28. Only that heat necessary to compensate for parasitic heat gain is discharged through ambient condenser 32.

Wash column salinity sensor 46 is used to monitor the degree of salinity stratification in flotation ice wash column 22. Saline water inlet pump 34 begins operation when two conditions are satisfied. First, wash column salinity sensor 46 must sense a degree of salinity below a preset level. Second, the harvest water salinity sensor 48 must confirm a degree of purity above a preset level in the water adjacent to condenser 28. When these conditions are satisfied the saline water inlet pump 34 will feed saline water into the crystallizer apparatus 26 which pushes fresh water out the top of the flotation ice wash column 22 and into the ice/water storage tank 24 where it can be harvested by fresh water pump 40. Saline water inlet pump 34 will stop when wash column salinity sensor 46 senses a preset elevation in salinity or when harvest water salinity sensor 48 senses a preset drop in the purity of the harvest water.

One consequence of feeding saline water into crystallizer apparatus 26 is an immediate lowering of the salinity of the water in crystallizer apparatus 26. Never-the-less, since no salt is leaving through the top of flotation ice wash column 22, and because the water in the flotation ice wash column 22 is stratified with greatest salinity in the crystallizer apparatus 26, we can expect the salinity in crystallizer apparatus 26 to steadily increase over time. Thus, when crystallizer salinity sensor 50 detects a degree of salinity exceeding a preset level, both the less saline water inlet pump 34 and the more saline water outlet pump 36 turn on with both pumping water into and out of crystallizer apparatus 26 at the same rate. Thereby we can reduce the salinity in crystallizer apparatus 26 to a preset level without making a net introduction or withdrawal of water from the flotation ice wash column 22.

In ice generation mode the apparatus of FIG. 2 initially operates in the Fresh Water Mode until the water in ice/water storage tank 24 reaches a preset level. At this time heat pump 30 begins to discharge all heat through ambient condenser 32 thereby sending a steady stream of ice crystals into ice/water storage tank 24.

In Ice Generation Mode the control of saline water inlet pump 34 and saline water outlet pump 36 by the three salinity sensors is as described above for Fresh Water Mode.

When it is desired to harvest the ice in the ice/water storage tank 24, circulation pump 44 circulates a secondary refrigerant around a loop consisting of ice melter 42 and air-conditioning heat exchangers (not shown).

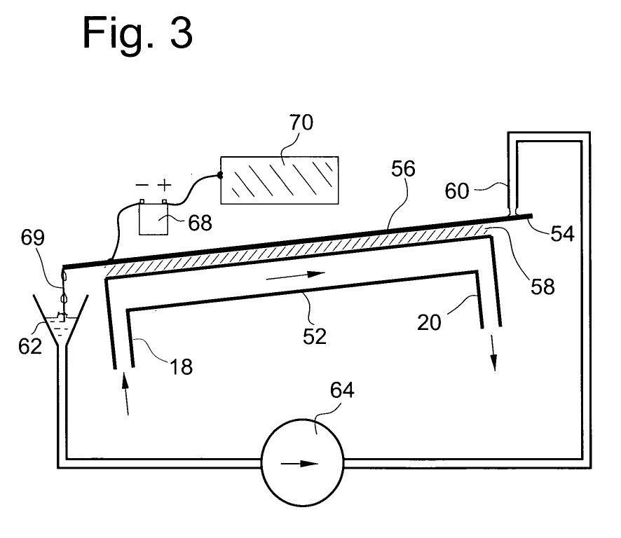

### DETAILED DESCRIPTION—FIG. 3—SECOND AND THIRD EMBODIMENT

The apparatus of FIG. 3 discloses three useful modifications that can be made to the apparatus of FIG. 1B. For the sake of clarity of exposition FIG. 3 is limited to the evaporator itself along with the three modifications.

FIG. 3 shows an flat rectangular heat pump evaporator 52 covered on its top by a rectangular sheet of nickel foil 54 having an upward facing mercury wetted surface 56. The nickel foil 54 is joined to the top face of evaporator 52 by thermal grease 58. This assembly;—evaporator 52 and mercury wetted surface 56—is oriented so that it is level along the z axis and slightly inclined along the x axis.

Mercury is deposited on the high end of mercury wetted surface 56 by a mercury nozzle 60. Mercury is collected at the low end of mercury wetted surface 56 by mercury wetted wire 61 which extends into mercury collector 62. Mercury is pumped from mercury collector 62 to mercury nozzle 60 by mercury pump 64.

A power supply 68 impresses a negative potential to mercury wetted surface 56 and to the surface of the mercury in mercury collector 62. Power supply 68 impresses a positive potential to anode 70 that is in close proximity to mercury wetted surface 56.

### Operation—FIG. 3

Mercury wetted surface 56 is joined to evaporator 52 by means of a thermal grease such as a beryllium oxide based silicone compound. By employing thermal grease 58, the nickel foil 54 and the mercury wetted surface 56 are not permanently joined to the evaporator 52. This is useful at the time of decommissioning of the apparatus because it allows the simple removal of the mercury wetted surface 56 in a way that greatly simplifies the process of recycling the mercury.

Mercury nozzle 60 is used to apply fresh mercury to the high end of mercury wetted surface 56. This mercury will wick across and flow down by means of gravity to the low end of mercury wetted surface 56 and drain off into mercury collector 62. This will renew the mercury surface and transport any solid matter that may have collected on the mercury wetted surface 56 across and off the mercury wetted surface 56. This process can be done periodically or continuously. The supply of mercury to mercury nozzle 60 can be new mercury (not shown) or a quantity of mercury can be periodically or continuously recycled by circulating the mercury using mercury pump 64.

Mercury wetted surface 56 and the surface of the mercury in mercury collector 62 are protected from ionization and corrosion by means of cathodic protection Cathodic protection is a method whereby metal atoms are prevented from acquiring positive charges (ionizing) by impressing a negative potential on the metal and thereby saturating the metal with negative charges (electrons). To cathodically protect a metal the power supply impressing the negative potential must also impress a positive potential to an anode that is joined to the to the metal being protected by an electrically conductive medium. In the case of FIG. 3 the electrically conductive medium would be the saline water. A suitable anode 70 would be made of graphite or gold plated metal and a suitable voltage for power supply 68 would be approximately one volt.

The purpose of mercury wetted wire 61 is to electrically join mercury wetted surface 56 to mercury collector 62 thereby providing cathodic protection to the mercury collector 62. Mercury wetted wire 61 is positioned so that as mercury drains off mercury wetted surface 56 it wicks down mercury wetted wire 61 thereby also providing cathodic protection to the mercury as it transfers from mercury wetted surface 56 to mercury collector 62.

By preventing ionization, the only remaining concern so far as mercury contamination is concerned is the process whereby un-ionized atoms of mercury go into solution. Atomic mercury is nearly insoluble in water. Using data obtained from Sanemara, I 1975 Bull. Chem. Soc. Jpn 48:1795-1798 the elemental saturated solubility of mercury in water with 7% dissolved salts and at −5 degree Celsius is approximately 9.2 micro grams per liter.

Given the purity of the product water from a flotation ice wash column we can expect virtually all of the dissolved elemental mercury from a cathodically protected mercury wetted surface crystallizer to exit the crystallizer via the waste water stream. Moreover, because the saline water in the crystallizer apparatus 26 lingers in the crystallizer for a limited period of time, we can expect that the quantity of atomic mercury in solution to be significantly less that the saturation value.

### CONCLUSION, RAMIFICATIONS, AND SCOPE

Accordingly, the reader will see that the cooling surfaces of the various embodiments are unique in their ability to prevent the adhesion of ice.

While the various embodiments are especially well suited for use in a flotation ice wash column these embodiments can also be used to good advantage with a gravity ice wash apparatus such as may be found in U.S. Pat. No. 4,517,806 to Korzonas (1985). In this latter application the crystallizer would typically be a separate free standing unit where the mercury wetted surface would typically occupy the floor of a horizontal water duct through which saline water is pumped.

The above detailed description has been given for clearness of understanding only. No unnecessary limitations should be understood therefrom, as modifications will be obvious to those skilled in the art.

I claim:

1. A dendritic ice crystallizer apparatus comprising:
(a) a metallic member having an upward facing substantially flat mercury wetted surface
(b) said mercury wetted surface immersed in water at the freezing temperature
(c) said metallic member being incorporated into or joined by heat conductive means to a cooling means
whereby said mercury wetted surface super cools the contiguous water thereby promoting the growth of dendritic ice crystals.

2. The apparatus of claim 1, further including cathodic protection means for said mercury wetted surface.

3. The apparatus of claim 1, wherein said mercury wetted surface is inclined from the horizontal, said apparatus further including:
(a) a mercury supply means disposed to deposit mercury on the high end of said mercury wetted surface
(b) a mercury collection means disposed to collect mercury spilling off the low end of said mercury wetted surface
whereby said mercury wetted surface is continuously or intermittently renewed in situ.

4. A method for growing dendritic ice crystals comprising:
(a) providing a substantially flat upward facing mercury wetted surface
(b) covering said mercury wetted surface with water at the freezing temperature
(c) extracting heat from said mercury wetted surface
thereby super cooling the water and promoting the growth of dendritic ice crystals.

5. The method of claim 4, wherein said mercury wetted surface is prevented from ionizing or corroding which method comprises:
(a) providing an anode immersed in said water in close proximity to said mercury wetted surface
(b) establishing a potential difference between said mercury wetted surface and said anode wherein said mercury wetted surface has a negative potential relative to said anode.

6. The method of claim 4 wherein said mercury wetted surface is continuously or intermittently renewed in situ which method comprises:
(a) inclining said mercury wetted surface from the horizontal
(b) depositing mercury at the high end of said mercury wetted surface
(c) collecting mercury from the low end of said mercury wetted surface.
